(19) United States
(12) Patent Application Publication
(10) Pub. No.: US 2011/0042932 A1
(43) Pub. Date: Feb. 24, 2011

(54) Fuel-efficient mud flaps

(76) Inventor: Richard Vogel, Wallingford, PA (US)

Correspondence Address: LAW OFFICE OF KYLE FLETCHER, P.O. Box 11735, CHARLOTTE, NC, 28220, US

(21) Appl. No.: 12/544,366

(22) Filed: Aug. 20, 2009

(51) Int. Cl. B62D 25/18

(52) U.S. Cl. 280/848; 280/154

(57) ABSTRACT

The mist and stone flaps consists of a first screen and a second screen, both of which are suspended via a bracket from behind a tire of a vehicle. The first screen is generally parallel with the second screen, and the first screen has a screen size different from that of the second screen. The first screen is also displaced from the second screen by a predetermined distance. A first embodiment provides a hinge that connects the bracket to the vehicle. A second embodiment connects the bracket directly to the vehicle. A third embodiment connects each screen to the vehicle independent of the other screen.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the field of mud flaps, more specifically, a mud flap that consists of a pair of differing screens that screen out debris from behind a tire or tires.

B. Discussion of the Prior Art

As a preliminary note, it should be stated that there is an ample amount of prior art that deals with mud flaps. As will be discussed immediately below, no prior art discloses a mud flap composed of a small screen that is generally parallel with a large screen by a specified distance and of which filters out flying debris such as mist, stones, pebbles, or rocks from behind a tire or tires in a fuel-efficient manner.

The Ogles et al. Patent (U.S. Pat. No. 7,014,211) discloses a bracket and mud flap assembly. However, the assembly does not consist of two screens that are generally parallel with one another, and wherein one screen has a larger screen size than the other.

The Nelson Patent Application Publication (U.S. Pub. No. 2008/0129031) discloses a spray protection device, which is attached in proximity to a vehicle wheel.

The Abercrombie Patent (U.S. Pat. No. 6,527,288) discloses a mud flap attachment device that is hinged. However, the device is directed to the attachment of a mud flap and not a new mud flap system involving screens and of which is also fuel-efficient.

The Simon Patent (U.S. Pat. No. 6,394,475) discloses a trailer guard that is capable of deflecting stones and dirt. However, the guard is composed of a brush as opposed to screens.

The Reed Patent (U.S. Pat. No. 4,627,594) discloses a mud flap mounting assembly. Again, the assembly is directed to mounting a mud flap thereon as opposed to a new mud flap that uses screens to filter debris and of which is fuel-efficient.

The Conner Patent (U.S. Pat. No. 3,877,722) discloses a mud flap apparatus for trucks. However, the mud flap apparatus does not involve a screen.

The Hammond, Jr. Patent (U.S. Pat. No. Des. 330,692) illustrates a design for a removable mud flap for vehicles, which depicts a removable mad flap not involving a screen.

The Bauer et al. Patent (U.S. Pat. No. 5,582,430) discloses a spray protection device for vehicles or vehicle trailers. However, the spray protection device does not involve screens of differing screen sizes that are generally parallel and of which provide a fuel-efficient means of adequately suppressing spray and debris from projecting from behind a tire.

The Evans Patent (U.S. Pat. No. 3,724,871) discloses a vehicle mud flap that deflects stones. Again, the mud flap does not involve screens as the means of suppressing spray and debris from projecting from behind a tire of a moving vehicle.

The Evans Patent (U.S. Pat. No. 3,899,193) discloses a mud flap mounting assembly that is hinged. Again, the mud flap does not involve screens as the means of suppressing spray and debris from projecting from behind a tire of a moving vehicle.

While the above-described devices fulfill their respective and particular objects and requirements, they do not describe a mad flap composed of a small screen that is generally parallel with a large screen by a specified distance and of which filters out flying debris from behind a tire or tires in a fuel-efficient manner. In this regard, the fuel-efficient mud flaps departs from the conventional concepts and designs of the prior art.

### SUMMARY OF THE INVENTION

The mist and stone fuel-efficient mud flaps consists of a first screen and a second screen, both of which are suspended via a bracket from behind a tire of a vehicle. The first screen is generally parallel with the second screen, and the first screen has a screen size different from that of the second screen. The first screen is also displaced from the second screen by a predetermined distance. A first embodiment provides a hinge that connects the bracket to the vehicle. A second embodiment connects the bracket directly to the vehicle. A third embodiment connects each screen to the vehicle independent of the other screen.

It is an object of the invention to provide a fuel-efficient mud flap that enables air to pass through the mud flap (thereby being fuel-efficient when compared to traditional mud flaps), but which screens out spray and small debris via screens.

A further object of the invention is to provide a fuel-efficient mad flap wherein multiple screens are generally parallel, and of which are separated by a pre-determined distance.

It is a further object of the invention to provide a fuel-efficient mud flap that has a hinge to enable rotational movement of the mud flap.

It is a further object of the invention to provide a fuel-efficient mud flap that does not include a hinge, but is rigidly affixed with respect to a vehicle.

These together with additional objects, features and advantages of the fuel-efficient mud flaps will be readily apparent to those of ordinary skill in the art upon reading the following detailed description of presently preferred, but nonetheless illustrative, embodiments of the fuel-efficient mud flaps when taken in conjunction with the accompanying drawings.

In this respect, before explaining the current embodiments of the fuel-efficient mud flaps in detail, it is to be understood that the fuel-efficient mud flaps is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the fuel-efficient mud flaps.

It is therefore important that the claims be regarded as including such equivalent construction insofar as they do not depart from the spirit and scope of the fuel-efficient mud flaps. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a front, isometric view of the first embodiment of the fuel-efficient mud flaps, and detailing the screen having the larger screen size;

FIG. 2 illustrates a rear, isometric view of the first embodiment of the fuel-efficient mud flaps, and detailing the screen having the smaller screen size;

FIG. 3 illustrates a side view of the first embodiment and detailing rotational movement of a mud flap via a hinge;

FIG. 4 illustrates a side view of the first embodiment installed upon a vehicle;

FIG. 5 illustrates a rear view of multiple mud flaps installed upon a trailer;

FIG. 6 illustrates a front, isometric view of the second embodiment of the fuel-efficient mud flaps without the hinge, and detailing the screen having the larger screen size;

FIG. 7 illustrates a rear, isometric view of the second embodiment of the fuel-efficient mud flaps without the hinge, and detailing the screen having the smaller screen size;

FIG. 8 illustrates the second embodiment installed upon a vehicle; and

FIG. 9 illustrates a third embodiment wherein each screen is attached individually to the vehicle.

### DETAILED DESCRIPTION OF THE EMBODIMENT

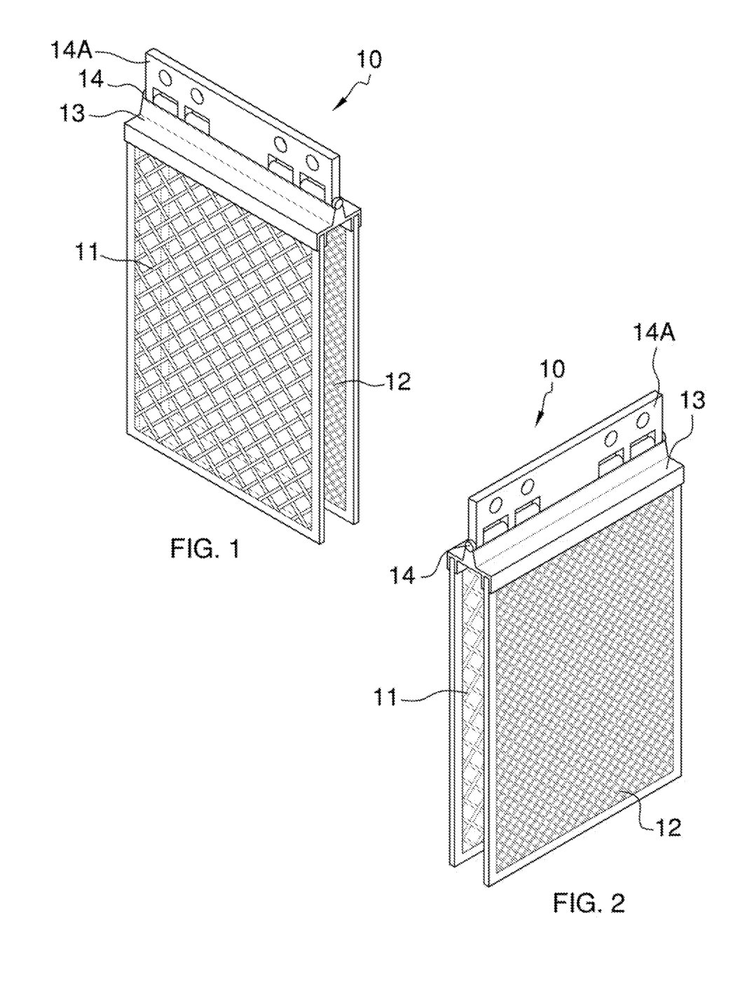

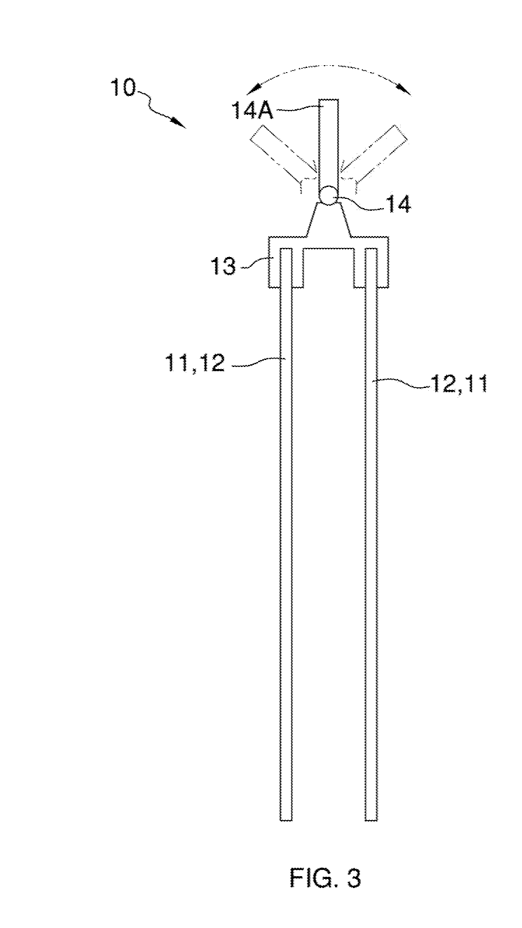

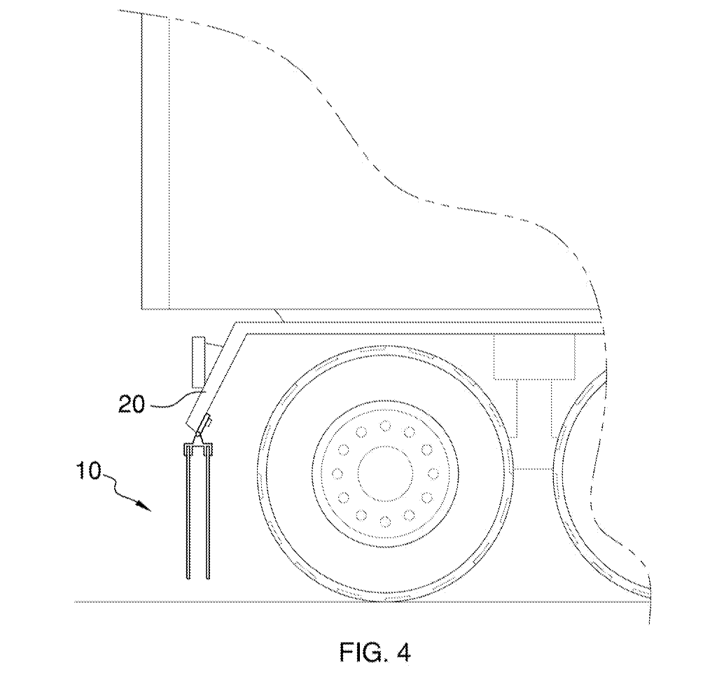

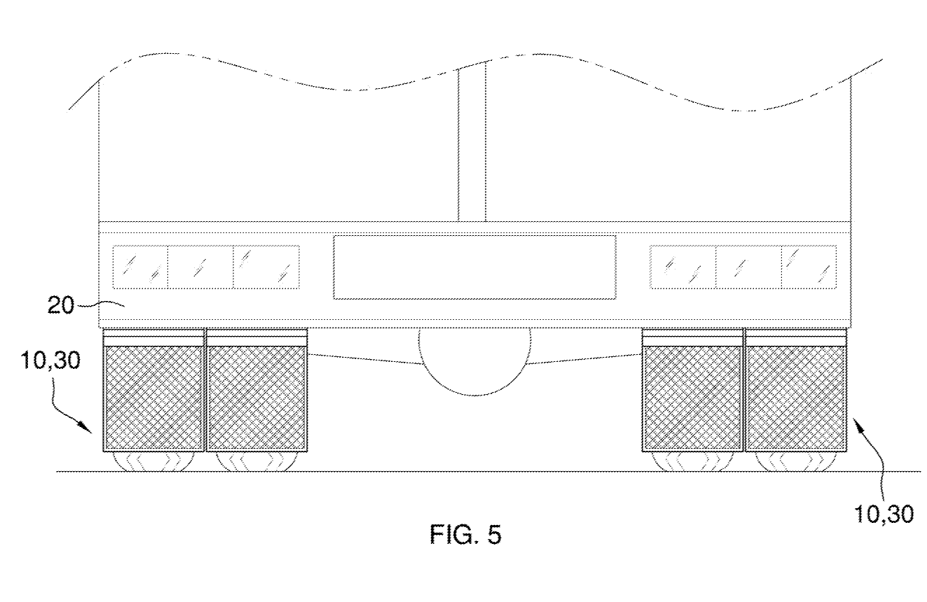

Detailed reference will now be made to the first embodiment of the present invention, examples of which are illustrated in FIGS. 1-5. A feel-efficient mud flap assembly 10 (hereinafter first embodiment) includes a first screen 11, a second screen 12, a bracket 13, and a hinge 14.

The first screen 11 has the same overall shape as the second screen 12, but has a larger screen size. The first screen 11 is designed to block or filter out large debris whereas the second screen 12 is designed to block out or filter out water spray from behind a vehicle 20 tire 21. Also, the first screen 11 is positioned closest to the tire 21 when compared to the second screen 12.

The first screen 11 is generally parallel with the second screen 12. Both the first screen 11 and the second screen 12 attach to the bracket 13, and are spaced apart by a predetermined distance. The bracket 13 connects to the vehicle 20 by the hinge 14.

The hinge 14 has an upper bracket 14A, which attaches to the vehicle 20 by an attaching means. The attaching means comprises bolting, welding, nailing, screwing, riveting, or use of adhesives.

The first screen 11, the second screen 12, the bracket 13, the hinge 14, and the upper bracket 14A are made of a material comprising a metal, plastic, or rubber.

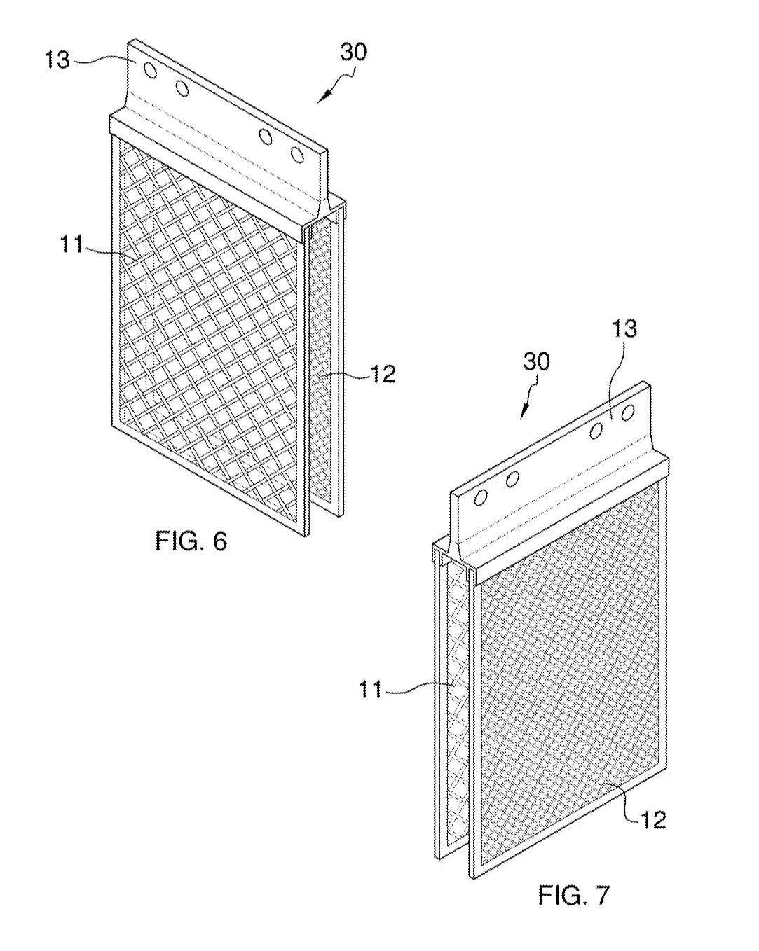

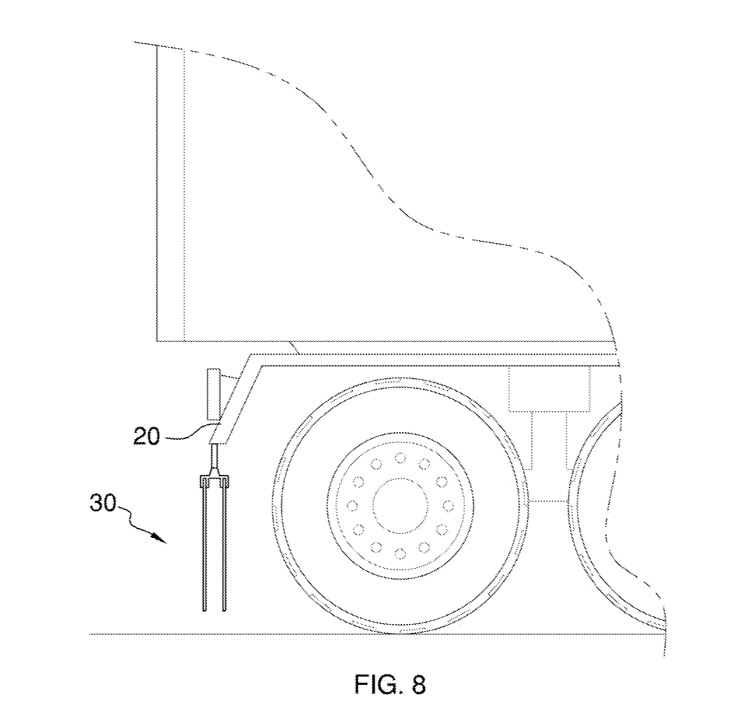

Detailed reference will now be made to the second embodiment of the present invention, examples of which are illustrated in FIGS. 6-8. A fuel-efficient mud flap assembly 30 (hereinafter second embodiment) includes the same components and features of she first embodiment described above, without the inclusion of the hinge 14 and upper bracket 14A. The second embodiment 30 uses the bracket 13 to attach directly to the vehicle 20. The exclusion of the hinge 14 provides a more rigid and stable embodiment that does not sway, and thus hinders any likelihood of the screens from touching the tire 21.

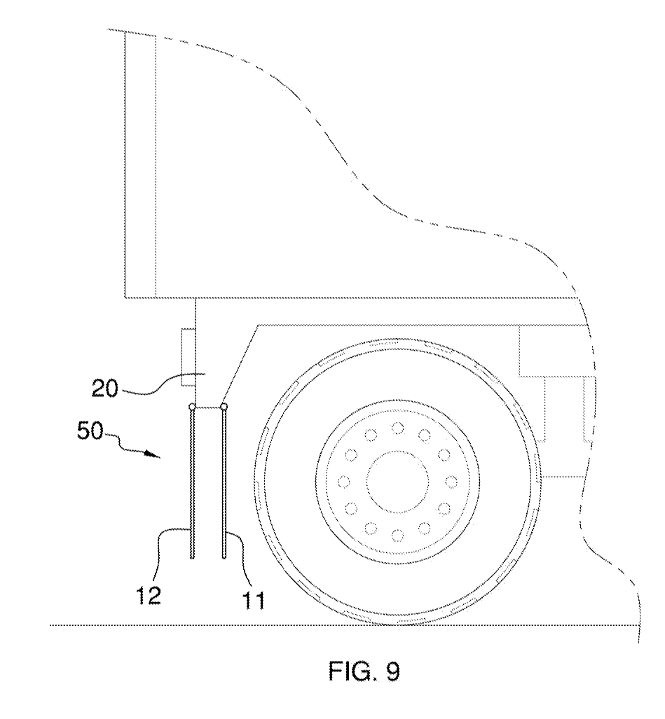

Detailed reference will now be made to a third embodiment 50, which is illustrated in FIG. 9. The third embodiment 50 includes a first screen 11 and a second screen 12 that are individually attached to the vehicle 20 via an attaching means as described in the above embodiments. The main difference in the third embodiment 50 is the lack of a hinge or bracket assembly. The first screen 11 and the second screen 12 are spaced apart from one another and attach directly to the vehicle 20.

The first embodiment 10, the second embodiment 30, and the third embodiment 50 are designed to enable air movement through both embodiments 10, 30, 50; but also to block out small debris (rocks, etc.) as well as water spray from being projected up from behind the tire 21. It is being asserted that the use of screens increases fuel efficiency of the vehicle 20.

With respect to the above description, it is to be realized that the optimum dimensional relationship for the various components of the first embodiment 10, the second embodiment 30, and the third embodiment 50 to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the first embodiment 10, the second embodiment 30, and the third embodiment 50.

It shall be noted that those skilled in the art will readily recognize numerous adaptations and modifications which can be made to the various embodiments of the present invention which will result in an improved invention, yet all of which will fail within the spirit and scope of the present invention as defined in the following claims. Accordingly, the invention is to be limited only by the scope of the following claims and their equivalents.

The inventor claims:

1. A fuel-efficient mist and stone flap for use with a vehicle tire further comprising:
a first screen and a second screen, and wherein the first screen is generally parallel with said second screen, and wherein the first screen is spaced from the second screen by a predetermined distance via a bracket, and wherein said bracket attaches to a vehicle in the rear vicinity of a tire.

2. The fuel-efficient mist and stone flap as described in claim 1 wherein the first screen has a larger screen size when compared to the second screen.

3. The fuel-efficient mist and stone flap as described in claim 1 wherein the first screen is closest said tire.

4. The fuel-efficient mist and stone flap as described in claim 1 wherein the first screen, the second screen, and the bracket are made of a material comprising a metal, plastic, or rubber.

5. The fuel-efficient mist and stone flap as described in claim 1 wherein the bracket attaches to said vehicle via an attaching means.

6. The fuel-efficient mist and stone flap as described in claim 5 wherein the attaching means comprises bolts, rivets, screws, welding, nailing, or adhesives.

7. A fuel-efficient mist and stone flap for use with a vehicle tire further comprising:
a first screen and a second screen, and wherein the first screen is generally parallel with said second screen, and wherein the first screen is spaced from the second screen by a predetermined distance via a bracket, and wherein said bracket is attached by a hinge to a vehicle in the rear vicinity of a tire, and wherein said hinge enables rotational movement of the mud flap.

8. The fuel-efficient mist and stone flap as described in claim 7 wherein the first screen has a larger screen size when compared to the second screen.

9. The fuel-efficient mist and stone flap as described in claim 7 wherein the first screen is closest said tire.

10. The fuel-efficient mist and stone flap as described in claim 7 wherein the first screen, the second screen, and the bracket are made of a material comprising a metal, plastic, or rubber.

11. The fuel-efficient mist and stone flap as described in claim 7 wherein the hinge attaches to said vehicle via an attaching means.

12. The fuel-efficient mist and stone flap as described in claim 11 wherein the attaching means comprises bolts, rivets, screws, welding, nailing, or adhesives.

13. A fuel-efficient mist and stone flap for use with a vehicle tire further comprising:
a first screen and a second screen, and wherein the first screen is generally parallel with said second screen, and wherein the first screen is spaced from the second screen by a predetermined distance, and wherein said first screen is attached to a vehicle in the rear vicinity of a tire, and wherein said second screen is attached to a vehicle in a rear vicinity of said tire, and wherein said first screen and second screen are rigidly attached to said vehicle.

14. The fuel-efficient mist and stone flap as described in claim 13 wherein the first screen has a larger screen size when compared to the second screen.

15. The fuel-efficient mist and stone flap as described in claim 13 wherein the first screen is closest said tire.

16. The fuel-efficient mist and stone flap as described in claim 13 wherein the first screen, the second screen are made of a material comprising a metal, plastic, or rubber.

17. The fuel-efficient mist and stone flap as described in claim 13 wherein the attaching means comprises bolts, rivets, screws, welding, nailing, or adhesives.
